(19) United States
(12) Patent Application Publication
(10) Pub. No.: US 2026/0030773 A1
(43) Pub. Date: Jan. 29, 2026

(54) METHOD AND SYSTEM FOR ESTIMATING LOCATION AND POSTURE OF OBJECT

(71) Applicants: Hyundai Motor Company, Seoul (KR); Kia Corporation, Seoul (KR)

(72) Inventors: Sanghyeon Oh, Hwaseong-si (KR); Dong Hwan Kwak, Hwaseong-si (KR); Hyuntek Lim, Hwaseong-si (KR)

(21) Appl. No.: 18/961,776

(22) Filed: Nov. 27, 2024

(30) Foreign Application Priority Data
Jul. 25, 2024 (KR) 10-2024-0098883

(51) Int. Cl. G06T 7/70; G05D 1/244; G05D 1/656; G05D 111/10; G06T 7/90

(52) U.S. Cl. CPC G06T 7/70; G05D 1/244; G05D 1/656; G06T 7/90; G05D 2111/10; G06T 2207/10028; G06T 2207/30204; G06T 2207/30252

(57) ABSTRACT

A method for estimating a location and a posture of an object, can include capturing, by a camera mounted on a robot, an image of the object, recognizing, by a controller, the mark from the image of the object, determining, by the controller, a main surface by using the recognized mark, determining, by the controller, a location of the mark disposed on the main surface, calculating, by the controller, a final center location and a final normal vector of the main surface by using the determined location of the mark and the specifications of the object, and calculating, by the controller, a center location and the posture of the object by using the final center location and the final normal vector of the main surface and the specifications of the object. A system for estimating a location and a posture of an object can be configured to execute such method.

### CROSS-REFERENCE TO RELATED APPLICATIONS

This application claims the benefit and priority of Korean Patent Application No. 10-2024-0098883, filed on Jul. 25, 2024, which application is hereby incorporated herein by reference.

### TECHNICAL FIELD

The present disclosure relates to a method and a system for estimating a location and a posture of an object using a camera mounted on a robot.

### BACKGROUND

Recently, the use of robots capable of autonomous driving is increasing. Such a robot may perform various tasks (for example, charging a vehicle parked in a parking lot) in addition to transporting people or cargo by the autonomous driving.

The tasks performed by the robot may include an individual task performed by one robot alone and an integrated task performed by a plurality of robots in cooperation. For the plurality of robots to perform the integrated task, one robot may be connected to another robot or follow another robot. For one robot to be connected to another robot or to follow another robot, the one robot is required to know the location and the posture of another robot.

There are various methods to determine the location and the posture of an object. In one example, a controller (processor) included in the robot may calculate the location and the posture of the object in real time through deep learning by using values detected by a camera or a light detection and ranging (LiDAR) sensor. However, it is difficult to apply the controller to an embedded system having low computational performance due to a large amount of computation necessary for calculating the location and the posture of the object in real time. In another example, the object may transmit its location and posture to the robot in real time. However, if communication between the object and the robot is cut off, the robot cannot determine the location and the posture of the object.

The above information disclosed in this Background section is provided only to assist in better understanding of the background of the present disclosure, and may thus include information not included in the prior art already publicly known, available, or in use.

### SUMMARY

The present disclosure relates to a method and a system for estimating a location and a posture of an object, and more particularly, to a method and a system for estimating the location and the posture of the object, in which the location and the posture of the object are estimated in real time by using a camera mounted on a robot.

An embodiment of the present disclosure can provide a method and a system for estimating a location and a posture of an object, in which the location and the posture of the object can be estimated in real time with a small amount of computation by using a camera mounted on a robot.

According to an embodiment of the present disclosure, a method for estimating a location and a posture of an object can be provided. The object can include at least one surface, each surface can be provided with at least one mark indicating the corresponding surface and disposed to be near a vertex of the corresponding surface, and a width and a height between the at least one mark and a center of the corresponding surface, and a width, a height, and a depth between the center of the corresponding surface and a center of the object can be pre-stored as specifications of the object.

The method can includes: capturing, by a camera mounted on a robot, an image of the object; recognizing, by a controller, the mark from the image of the object; determining, by the controller, a main surface by using the recognized mark; determining, by the controller, a location of the mark disposed on the main surface; calculating, by the controller, a final center location and a final normal vector of the main surface by using the determined location of the mark and the specifications of the object; and calculating, by the controller, a center location and the posture of the object by using the final center location and the final normal vector of the main surface and the specifications of the object.

The mark may be a light-emitting diode that emits light of a color set based on the surface on which the mark is disposed.

The image of the object that is captured by the camera may include information on the color of the light-emitting diode in the image, information on pixel data of the light-emitting diode in the image, and/or information on a transformation relationship between the pixel data and three-dimensional (3D) data of the light-emitting diode, and the 3D data may include depth data.

In the recognizing of the mark from the image of the object, at least the color of light emitted by the light-emitting diode and pixel data of a vertex of an N*N sized bounding box corresponding to the light-emitting diode may be detected.

The determining a main surface by using the recognized mark may include determining, as the main surface, a surface on which the largest number of vertices are disposed among all the detected vertices.

The determining a location of the mark disposed on the main surface may include generating 3D data of the vertex of the bounding box corresponding to the light-emitting diode disposed on the main surface, calculating at least two-dimensional (2D) data of a center and a normal vector of an i-th light-emitting diode based on the 3D data of the vertex of the bounding box corresponding to the i-th light-emitting diode and a size of the bounding box, determining whether the i-th light-emitting diode is disposed on a left or a right in a width direction by moving the i-th light-emitting diode to the left or the right in the width direction, and determining whether the i-th light-emitting diode is disposed above or below in a height direction by determining whether a height of the center of the i-th light-emitting diode based on the camera is above or below a height of the center of the object.

The determining whether the i-th light-emitting diode is disposed on a left or a right in a width direction by moving the i-th light-emitting diode to the left or the right in the width direction may include calculating a difference between the normal vector before movement and the normal vector after the movement by moving the i-th light-emitting diode to the left or the right by a predetermined distance in the width direction, determining that the i-th light-emitting diode is disposed in a movement direction if the difference between the normal vector before the movement and the normal vector after the movement is greater than a predetermined value, and determining that the i-th light-emitting diode is disposed in a direction opposite to the movement direction if the difference between the normal vector before the movement and the normal vector after the movement is the predetermined value or less.

The calculating a final center location and a final normal vector of the main surface by using the determined location of the mark and the specifications of the object may include calculating a center location and a normal vector of the main surface for all the light-emitting diodes disposed on the main surface based on data of the center of the light-emitting diode and the specifications of the object, and calculating the center location and the normal vector of the main surface for all the light-emitting diodes disposed on the main surface by using the calculated center location and the calculated normal vector of the main surface.

The calculating the center location and the normal vector of the main surface for all the light-emitting diodes disposed on the main surface by using the calculated center location and the calculated normal vector of the main surface may include filtering the center location and the normal vector of the main surface, calculated for all the light-emitting diodes disposed on the main surface.

The method may further include controlling, by the controller, the robot based on the center location and the posture of the object.

According to an embodiment of the present disclosure, a system for estimating a location and a posture of an object can be provided. The object can include at least one surface, each surface can be provided with at least one mark indicating the corresponding surface and disposed to be near a vertex of the corresponding surface, and a width and a height between the at least one mark and a center of the corresponding surface, and a width, a height, and a depth between the center of the corresponding surface and a center of the object can be pre-stored as specifications of the object.

The system can include: a robot including a driver for generating a driving force and configured to follow or engage with the object; a camera mounted on the robot and configured to capture an image of the object within a field of view; and a controller connected to the camera, configured to receive the image of the object from the camera, and configured to control the robot.

The controller may be configured to: recognize the mark from the image of the object; determine a main surface by using the recognized mark; determine a location of the mark disposed on the main surface; calculate a final center location and a final normal vector of the main surface by using the determined location of the mark and the specifications of the object; and calculate a center location and the posture of the object by using the final center location and the final normal vector of the main surface and the specifications of the object.

The mark may be a light-emitting diode that emits light of a color set based on the surface on which the mark is disposed.

The image of the object that is captured by the camera may include information on the color of the light-emitting diode in the image, information on pixel data of the light-emitting diode in the image, and/or information on a transformation relationship between the pixel data and three-dimensional (3D) data of the light-emitting diode, and the 3D data may include depth data.

When recognizing the mark from the image of the object, the controller may be configured to detect at least the color of light emitted by the light-emitting diode and pixel data of a vertex of an N*N sized bounding box corresponding to the light-emitting diode.

When determining the main surface by using the recognized mark, the controller may be configured to determine, as the main surface, a surface on which the largest number of vertices are disposed among all the detected vertices.

When determining the location of the mark disposed on the main surface, the controller may be configured to generate 3D data of the vertex of the bounding box corresponding to the light-emitting diode disposed on the main surface, calculate at least two-dimensional (2D) data of a center and a normal vector of an i-th light-emitting diode based on the 3D data of the vertex of the bounding box corresponding to the i-th light-emitting diode and a size of the bounding box, determine whether the i-th light-emitting diode is disposed on a left or a right in a width direction by moving the i-th light-emitting diode to the left or the right in the width direction, and determine whether the i-th light-emitting diode is disposed above or below in a height direction by determining whether a height of the center of the i-th light-emitting diode based on the camera is above or below a height of the center of the object.

When determining whether the i-th light-emitting diode is disposed on the left or the right in the width direction by moving the i-th light-emitting diode to the left or the right in the width direction, the controller may be configured to calculate a difference between the normal vector before the movement and the normal vector after the movement by moving the i-th light-emitting diode to the left or the right by a predetermined distance in the width direction, determine that the i-th light-emitting diode is disposed in a movement direction if the difference between the normal vector before the movement and the normal vector after the movement is greater than a predetermined value, and determine that the i-th light-emitting diode is disposed in a direction opposite to the movement direction if the difference between the normal vector before the movement and the normal vector after the movement is the predetermined value or less.

When calculating the final center location and the final normal vector of the main surface by using the determined location of the mark and the specifications of the object, the controller may be configured to calculate a center location and a normal vector of the main surface for all the light-emitting diodes disposed on the main surface based on data of the center of the light-emitting diode and the specifications of the object, and calculate the center location and the normal vector of the main surface for all the light-emitting diodes disposed on the main surface by using the calculated center location and the calculated normal vector of the main surface.

When calculating the center location and the normal vector of the main surface for all the light-emitting diodes disposed on the main surface by using the calculated center location and the calculated normal vector of the main surface, the controller can be configured to filter the center location and the normal vector of the main surface, calculated for all the light-emitting diodes disposed on the main surface.

The controller may be further configured to control the robot based on the center location and the posture of the object.

As set forth above, according to an embodiment of the present disclosure, the light-emitting diode indicating each surface may be mounted on the corresponding surface of the object, and the light-emitting diode may be recognized by the camera mounted on the robot. The main surface may be determined using the recognized light-emitting diode, and the location and the posture of the object may be calculated based on the 3D data of the light-emitting diode disposed on the main surface and the specification of the object. Therefore, the location and the posture of the object may be estimated in real time with the small amount of computation using an embodiment of the present disclosure.

According to an embodiment of the present disclosure, the connection to the object or the follow-up of the object may be controlled using the estimated location and posture of the object.

Other advantages that may be acquired or predicted by an embodiment of the present disclosure are disclosed directly or implicitly in the detailed description of example embodiments of the present disclosure. That is, various advantages predicted based on example embodiments of the present disclosure are disclosed in the detailed description described below.

### BRIEF DESCRIPTION OF THE DRAWINGS

Example embodiments in the specification may be better understood by reference to the following description in connection with the accompanying drawings in which like reference numerals can refer to identical or functionally similar elements.

FIG. 1 is a block diagram of a system for estimating a location and a posture of an object according to an embodiment of the present disclosure.

FIG. 2 is a schematic diagram showing one surface (for example, a side surface) of an object according to an example embodiment of the present disclosure.

FIG. 3 is a schematic diagram showing another surface (for example, a front surface or a rear surface) of an object according to an example embodiment of the present disclosure.

FIG. 4 is a flow chart of a method for estimating a location and a posture of an object according to an embodiment of the present disclosure.

FIG. 5 is a detailed flow chart of operation S150 in FIG. 4.

FIG. 6 schematically shows a specification of one surface of an object according to an example embodiment of the present disclosure.

FIG. 7 schematically shows a center location of a light-emitting diode disposed on one surface of an object according to an example embodiment of the present disclosure.

FIG. 8 schematically shows a center location and a normal vector of one surface of an object, and a location and a posture of the center of the object according to an example embodiment of the present disclosure.

It can be understood that the drawings referenced above are not necessarily drawn to scale, and present a rather simplified representation of various features illustrating some basic principles of example embodiments of the present disclosure. For example, specific design features of example embodiments of the present disclosure, including a specific dimension, orientation, position, and shape, can be determined in part by the particularly intended application and environment of use.

### DETAILED DESCRIPTION OF ILLUSTRATIVE EMBODIMENTS

A term used herein to describe specific example embodiments is not intended to necessarily limit the present disclosure. A term of a single number used herein can be intended to include its plural number unless the context clearly indicates otherwise. It can be understood that the terms “include” and/or “including”, when used in the specification, can specify the presence of the recited features, integers, steps, operations, elements, and/or components, and do not exclude the presence or addition of one or more of other features, integers, steps, operations, elements, components, and/or groups thereof. As used herein, a term “and/or” can include any one or all combinations of the associated listed items.

The term “robots” or other similar terms used herein can include general robots capable of moving on land including passenger cars including sports utility vehicles (SUVs), buses, trucks, various commercial vehicles, etc., robots capable of moving on the sea including various boats and ships, and robots capable of moving on the air including aircraft, drones, etc., and include any object capable of moving by receiving power from a power source. The term “robots” or other similar terms used herein can include hybrid powered robots, electric powered robots, plug-in hybrid powered robots, hydrogen powered robots, and other alternative fuel (e.g., fuel derived from resources other than petroleum) robots. As mentioned herein, hybrid powered robots can include robots with two or more power sources, such as gasoline powered and electric power robots. A robot according to an embodiment of the present disclosure can include not only a manually driven robot but also a robot that is somewhat autonomously and/or automatically driven.

It can be understood that one or more of methods described below may be executed by at least one controller. The term “controller” may refer to a hardware device including a memory and a processor. The memory may store program instructions, and the processor may be specifically programmed to execute the program instructions to perform one or more processes described below in more detail. The controller may control operations of units, modules, components, devices, or the like, as described herein. It can be understood that the methods described below may be executed by an apparatus including the controller in conjunction with one or more other components, as appreciated by those skilled in the art.

The controller of an embodiment of the present disclosure may be implemented as a non-transitory computer-readable recording medium including executable program instructions executed by the processor. An example of the computer-readable recording medium may include a read only memory (ROM), a random access memory (RAM), a compact disk read only memory (CD-ROM), a magnetic tape, a floppy disk, a flash drive, a smart card, or an optical data storage device, and is not limited thereto. The computer-readable recording medium may also be distributed throughout a computer network, and the program instructions may thus be stored and executed in a distributed manner, for example, on a telematics server or a controller area network (CAN).

Hereinafter, example embodiments of the present disclosure are described in detail with reference to the accompanying drawings.

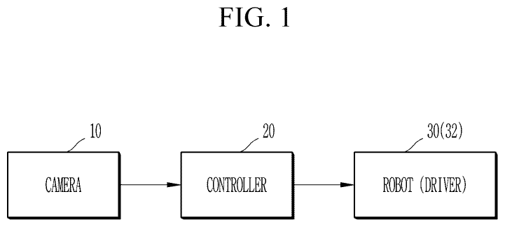

FIG. 1 is a block diagram of a system for estimating a location and a posture of an object according to an embodiment of the present disclosure.

As shown in FIG. 1, a system for estimating a location and a posture of an object according to an embodiment of the present disclosure may include a camera 10, a controller 20, and a robot 30.

The camera 10 may be mounted on the robot 30 and capture an image of an object 40 within a field of view of the camera 10. The image of the object 40 may include information on the object 40, for example, information on a color of a feature point (for example, a light-emitting diode) in the object 40, information on pixel data of the feature point (pixel data of a vertex of a bounding box corresponding to the light-emitting diode) in the object 40, and/or information on a transformation relationship between the pixel data of the feature point in the object 40 and three-dimensional (3D) data of the corresponding feature point. The 3D data may include depth data. The bounding box may be an N*N square corresponding to the light-emitting diode, but may have any suitable shape. For convenience of explanation, the specification exemplifies the bounding box as the N*N sized square. In one example, the pixel data of the feature point indicates (Px, Py), each of which is coordinate of each vertex of the bounding box in two-dimensional (2D) image. The three-dimensional data may include an x-coordinate in a first direction (corresponding to a width direction), a y-coordinate in a second direction (corresponding to a height direction) perpendicular to the first direction, and a z-coordinate in a third direction (corresponding to a depth direction) perpendicular to the first and second directions. However, the 3D data is not limited thereto, and may be any 3D data including the depth data known to those skilled in the art.

The controller 20 may be connected to the camera 10 and receive the image of the object 40 from the camera 10. The controller 20 may recognize the feature points from the image of the object 40. In more detail, the controller 20 may recognize, from the image of the object 40, the color of the feature point (for example, the light-emitting diode) in the object 40, the pixel data of the feature point (the pixel data of the vertex of the bounding box corresponding to the light-emitting diode) in the object 40, and/or the 3D data of the feature point (the 3D data of the vertex of the bounding box corresponding to the light-emitting diode) in the object 40.

The controller 20 may determine a main surface of the object 40 based on the information on the color of the feature point in the object 40, and determine the location and the posture of the object 40 based on the 3D data of the feature point on the main surface. The controller 20 may control an operation of the robot 30 based on the location and the posture of the object 40. The controller 20 may be configured to perform each step/operation of a method for estimating the location and the posture of the object 40 according to an embodiment of the present disclosure. The controller 20 may be mounted on the robot 30 and/or may be provided remotely from the robot 30.

The robot 30 may be connected to the controller 20, and the operation of the robot 30 may be controlled by the controller 20. The robot 30 may include at least the controller 20, an energy storage device, a sensor system, and a driver 32. In addition, the sensor system can include at least the camera 10.

The energy storage device may be mounted in the robot 30, and may receive and store electric energy from a charging station under the control of the controller 20 or discharge the electric energy to drive the driver 32.

The driver 32 may be mounted on the robot 30, and receive power from the energy storage device to move the robot 30. The driver 32 may include, but is not limited thereto, at least one wheel and at least one drive motor connected to the at least one wheel and rotating the at least one wheel. The driver 32 may further include a steering device for steering the robot 30.

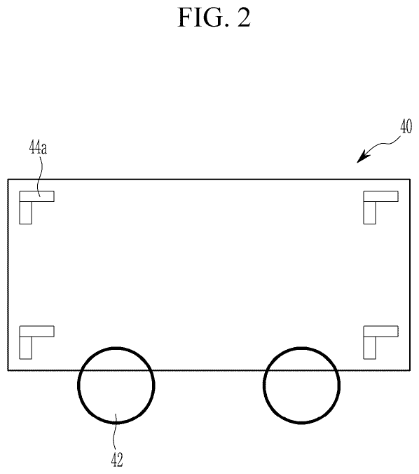

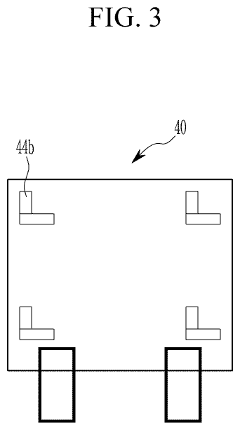

The object 40 may include at least one surface that may be recognized by the camera 10 to perform the method for estimating the location and the posture of the object 40 according to an embodiment of the present disclosure by using the system for estimating the location and the posture of the object 40. FIG. 2 is a schematic diagram showing one surface (for example, a side surface) of an object according to an example. FIG. 3 is a schematic diagram showing another surface (for example, a front surface or a rear surface) of an object according to an example.

As shown in FIGS. 2 and 3, the object 40 may include a plurality of surfaces that may be recognized by the camera 10, and each surface can be provided with a mark indicating the corresponding surface. In one example, the mark may be a light-emitting diode (LED) 44a or 44b that emits light of one color. For example, one surface (for example, a side surface) of the object 40 may be provided with the light-emitting diode 44a emitting red light, and another surface (for example, a front or rear surface) of the object 40 may be provided with the light-emitting diode 44b emitting green light. The camera 10 may identify the surface of the object 40 that is captured by the camera 10 by identifying the color emitted by the light-emitting diode 44a or 44b. For example, if the camera 10 identifies a red color, the camera 10 may recognize as capturing the side surface of the object 40, and if the camera 10 identifies a green color, the camera 10 may recognize as capturing the front or the rear surface of the object 40.

If the camera 10 identifies the red and green colors together, the camera 10 may recognized as simultaneously capturing the side and front surfaces of the object 40 or the side and rear surfaces of the object 40. In this case, the controller 20 may determine the main surface of the object 40 among the side surface and the front or rear surface of the object 40. Here, the main surface may indicate a surface mounted with the largest number of light-emitting diodes 44a or 44b indicating one surface among the light-emitting diodes 44a and 44b identified by the camera 10. Any of one surface and another surface may be set as the main surface if the number of the light-emitting diodes 44a indicating the one surface is equal to the number of the light-emitting diodes 44b indicating another surface. The mark is not limited to the light-emitting diode, and may be any mark that may indicate each surface of the object 40.

The object 40 may be movable. Accordingly, the object 40 may have a driver 42 similar to the driver 32 of the robot 30. In one example, the object 40 may be one type of the robot 30. However, the object 40 is not limited to the movable object 40, and may be a fixed object fixed to the ground, such as the charging station.

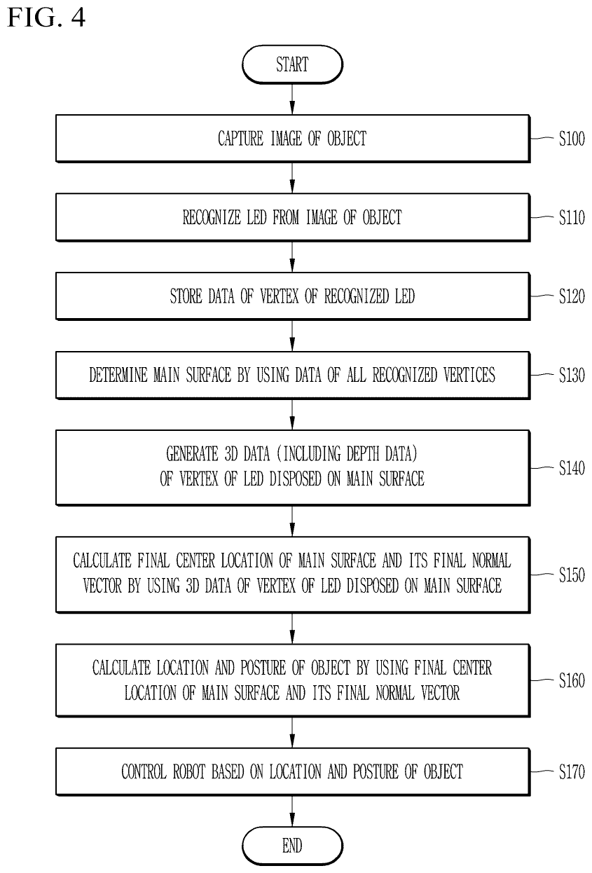

Hereinafter, the description describes a method for estimating the location and the posture of the object according to an example embodiment of the present disclosure is described in detail with reference to FIGS. 4 to 8.

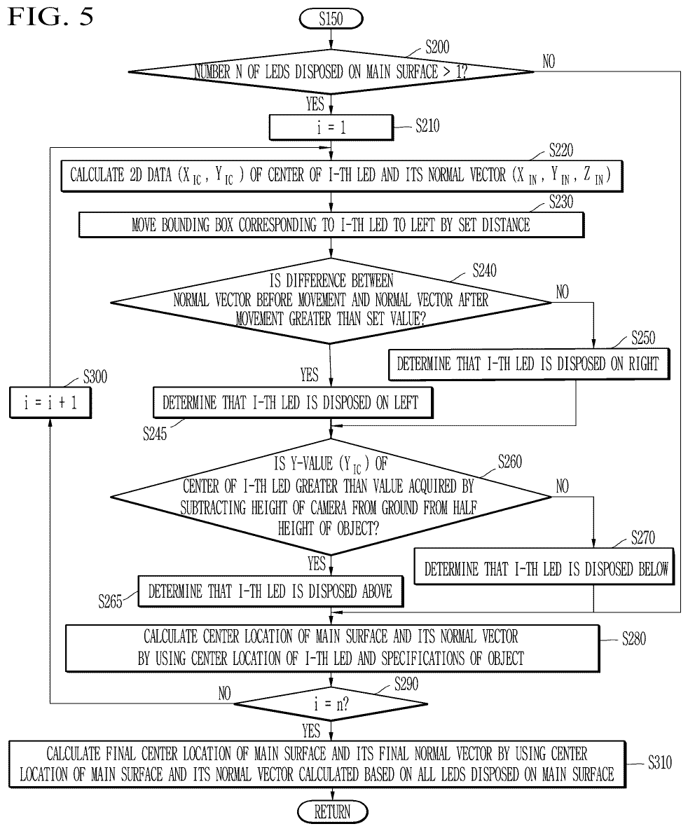

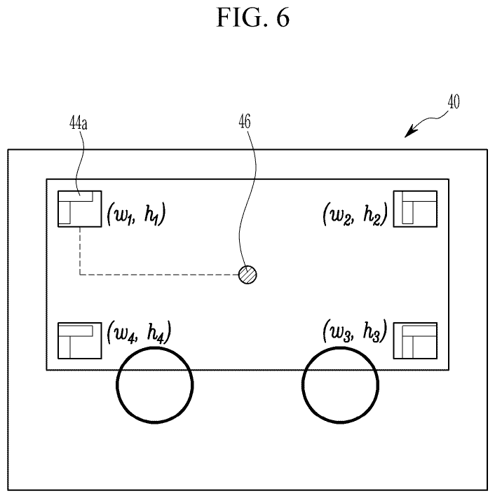

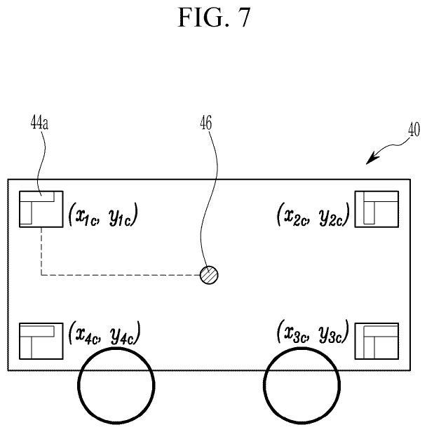

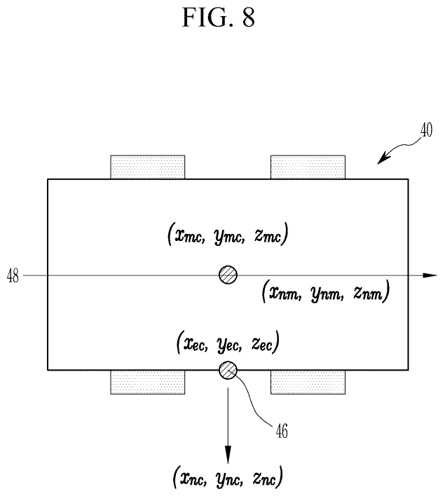

FIG. 4 is a flow chart of a method for estimating a location and a posture of an object according to an embodiment of the present disclosure. FIG. 5 is a detailed flow chart of operation S150 in FIG. 4. FIG. 6 schematically shows a specification of one surface of an object according to an example. FIG. 7 schematically shows a center location of a light-emitting diode disposed on one surface of an object according to an example. FIG. 8 schematically shows a center location and a normal vector of one surface of an object, and a location and a posture of the center of the object according to an example.

As shown in FIG. 4, the method for estimating the location and the posture of the object according to an embodiment of the present disclosure may start at operation S100. At the operation S100, the camera 10 may capture the image of the object 40 within the field of view, and transmit the image of the object 40 to the controller 20. Here, the object 40 may include the plurality of surfaces that may be recognized by the camera 10, each surface may be provided with at least one mark indicating the corresponding surface, and the feature point of the object 40 may include the at least one mark. In one example, the mark may indicate the light-emitting diode 44a or 44b disposed to be near the vertex (for example, an upper left vertex, a lower left vertex, an upper right vertex, or a lower right vertex) of the surface, the light-emitting diode 44a or 44b may emit light of a specific color based on the surface mounted with the LED, and the image of the object 40 may include the information on the color of the light emitted by the light-emitting diode 44a or 44b.

The image of the object 40 may include the information on the pixel data of the vertex of the bounding box corresponding to the light-emitting diode 44a or 44b, and/or the information on the transformation relationship between the pixel data of the vertex of the bounding box corresponding to the light-emitting diode 44a or 44b and the 3D data of the vertex of the bounding box of the light-emitting diode 44a or 44b. Here, the bounding box may be the N*N square (or rectangle) corresponding to the light-emitting diode, and one bounding box may thus have four vertices.

The controller 20 may recognize the light-emitting diode 44a or 44b from the image of the object 40 at operation S110, and store the data of the vertex of the bounding box corresponding to the recognized light-emitting diode 44a or 44b at operation S120. Here, “recognizing the light-emitting diode 44a or 44b” can indicate detecting at least the color of the light emitted by the light-emitting diode 44a or 44b and the pixel data of the vertex of the bounding box corresponding to the light-emitting diode 44a or 44b. The data of the vertex of the bounding box corresponding to the light-emitting diode 44a or 44b may be stored in a form of (Px, Py, wᵢ, hᵢ, m). Here, Px and Py can indicate the pixel data of the vertex of the bounding box; m can be a number indicating a surface of the object 40 (for example, m of the front surface is 1, m of the left surface is 2, m of the rear surface is 3, and m of the right surface is 4); and wᵢ and hᵢ can indicate a width and a height, between the center of the bounding box corresponding to an i-th light-emitting diode 44a and a center 46 of the surface on which the light-emitting diode 44a can be disposed, as shown in FIG. 6. wᵢ and hᵢ may be pre-stored in a memory of the controller 20 as specifications of the object 40.

When the data of the vertex of the bounding box corresponding to the light-emitting diode 44a or 44b are stored, the controller 20 may determine the main surface by using the data of all the recognized vertices at operation S130. In more detail, the controller 20 may determine m having the largest number from the data of all the recognized vertices, and determine a surface indicated by m as the main surface. If the number of one m and the number of another m are the largest and equal to each other, the controller 20 may then set, as the main surface, any one of the surfaces indicated by the one m and the surface indicated by another m.

When the main surface is determined, the controller 20 may generate the 3D data of the vertex of the bounding box corresponding to the light-emitting diode 44a disposed on the main surface at operation S140. The controller 20 may generate the 3D data of the vertex of the bounding box corresponding to the light-emitting diode 44a disposed on the main surface based on the data of the vertex of the bounding box stored at the operation S120 and the transformation relationship between the pixel data of the vertex of the bounding box included in the image of the object 40 and the 3D data of the corresponding vertex.

The controller 20 may then calculate a final center location of the main surface and its final normal vector by using the 3D data of the vertex of the bounding box corresponding to the light-emitting diode 44a disposed on the main surface at operation S150. The operation S150 is described in more detail with reference to FIG. 5.

As shown in FIG. 5, the operation S150 starts at operation S200. At the operation S200, the controller 20 may determine whether a number n of the light-emitting diodes 44a disposed on the main surface is greater than 1. If the number n of the light-emitting diodes 44a disposed on the main surface at operation S200 is greater than 1, the controller 20 may assign 1 to “i” at operation S210, and calculate at least 2D data (x_{ic}, y_{ic}) of the center of the i-th light-emitting diode 44a and its normal vector (xᵢₙ, yᵢₙ, zᵢₙ) as shown in FIG. 7 at operation S220. The controller 20 may calculate the 2D data (x_{ic}, y_{ic}) of the center of the i-th light-emitting diode 44a and its normal vector (xᵢₙ, yᵢₙ, zᵢₙ) by using a pre-stored algorithm based on the 3D data (xᵢⱼ, yᵢⱼ, zᵢⱼ) of the vertex of the bounding box corresponding to the i-th light-emitting diode 44a and a size of the bounding box. Here, the subscript ij indicates a j-th vertex of the i-th light-emitting diode 44a. The description omits a detailed description of the example algorithm because this example algorithm for calculating the 3D data (x_{ic}, y_{ic}, z_{ic}) of the center of the corresponding bounding box and its normal vector (xᵢₙ, yᵢₙ, zᵢₙ) from the 3D data (xᵢⱼ, yᵢⱼ, zᵢⱼ) of the vertex of the bounding box of the known size (N*N) is well known to those skilled in the art.

When at least the 2D data (x_{ic}, y_{ic}) of the center of the i-th light-emitting diode 44a and its normal vector (xᵢₙ, yᵢₙ, zᵢₙ) are calculated, the controller 20 may move the bounding box corresponding to the i-th light-emitting diode 44a to the left by a predetermined distance at operation S230, and determine whether a difference between the normal vector before the movement and the normal vector after the movement is greater than a predetermined value at operation S240. If the center of the i-th light-emitting diode 44a is disposed on the left of the main surface, the light-emitting diode 44a may be disposed on a surface other than the main surface by being moved to the left by the predetermined distance. Accordingly, the difference between the normal vector before the movement and the normal vector after the movement may be greater than the predetermined value, and the controller 20 may determine that the i-th light-emitting diode 44a is disposed on the left at operation S245. On the other hand, if the center of the i-th light-emitting diode 44a is disposed on the right of the main surface, the light-emitting diode 44a may still be disposed on the main surface even when the light-emitting diode 44a is moved to the left by the predetermined distance. Accordingly, the difference between the normal vector before the movement and the normal vector after the movement may be smaller than the predetermined value, and the controller 20 may determine that the i-th light-emitting diode 44a is disposed on the right at operation S250. The predetermined distance may be set based on a distance between the light-emitting diode 44a mounted on any surface and a left edge of the corresponding surface. There are various methods of calculating the difference between the normal vector before the movement and the normal vector after the movement, and the predetermined value may be set based to the selected method.

In an embodiment of the present disclosure, the controller 20 can determine whether the i-th light-emitting diode 44a is disposed on the left or the right by moving the bounding box corresponding to the i-th light-emitting diode 44a to the left by the predetermined distance. However, the controller 20 may also determine whether the i-th light-emitting diode 44a is disposed on the left or the right by moving the bounding box corresponding to the i-th light-emitting diode 44a to the right by the predetermined distance. In this case, the controller 20 may determine that the i-th light-emitting diode 44a is disposed on the right if the difference between the normal vector before the movement and the normal vector after the movement is greater than the predetermined value, and determine that the i-th light-emitting diode 44a is disposed on the left if the difference between the normal vector before the movement and the normal vector after the movement is the predetermined value or less.

The controller 20 may determine whether a y-value of the center of the i-th light-emitting diode 44a is greater than a value acquired by subtracting a mounting height of the camera 10 from the ground from half a height of the object 40 at operation S260. That is, the controller 20 may determine whether a height of the center of the i-th light-emitting diode 44a based on the camera 10 is greater than a height of the center of the object 40. The controller 20 may determine that the i-th light-emitting diode 44a is disposed above at operation S265 if the height of the center of the i-th light-emitting diode 44a based on the camera 10 is greater than the height of the center of the object 40 (“yes” at the operation S260), and determine that the i-th light-emitting diode 44a disposed below at operation S270 if the height of the center of the i-th light-emitting diode 44a based on the camera 10 is smaller than the height of the center of the object 40 (“no” at the operation S260).

The controller 20 may calculate a location (x_{ec}, y_{ec}, z_{ec}) of the center 46 of the main surface and its normal vector (x_{nc}, y_{nc}, z_{nc}) based on the data (x_{ic}, y_{ic}, z_{ic}) of the center of the i-th light-emitting diode 44a and the specifications of the object (for example, at least wᵢ, hᵢ) at operation S280 when the location of the i-th light-emitting diode 44a is determined (see FIG. 8). For example, the controller 20 may calculate a 2D location of the center 46 of the main surface by the sum of the 2D data (x_{ic}, y_{ic}) of the center of the i-th light-emitting diode 44a and the specifications (wᵢ, hᵢ) of the object, and calculate the depth data (z_{ec}) of the center 46 of the main surface by the depth data at the 2D location (x_{ec}, y_{ec}) of the center 46 of the main surface. The controller 20 may calculate the normal vector (x_{nc}, y_{nc}, z_{nc}) of the center 46 of the main surface as the normal vector at the location (x_{ec}, y_{ec}, z_{ec}) of the center 46 of the main surface.

The controller 20 may then determine whether “i” is equal to the number n of the light-emitting diode 44a disposed on the main surface at operation S290. If at the operation S290, “i” is different from the number n of the light-emitting diode 44a disposed on the main surface, the controller 20 may add 1 to “i” at operation S300, return to the operation S220, and repeat the operations S220 to S280. If “i” is equal to the number n of the light-emitting diode 44a disposed on the main surface at the operation S290, the controller 20 may calculate the location (x_{ec}, y_{ec}, z_{ec}) of the final center 46 of the main surface and its final normal vector (x_{nc}, y_{nc}, z_{nc}) by using the location (x_{ec}, y_{ec}, z_{ec}) of the center 46 of the main surface and its normal vector (x_{nc}, y_{nc}, z_{nc}), which are calculated based on all the light-emitting diodes 44a disposed on the main surface at operation S310. The controller 20 may calculate the location (x_{ec}, y_{ec}, z_{ec}) of the final center 46 of the main surface and its final normal vector (x_{nc}, y_{nc}, z_{nc}) by correcting the location (x_{ec}, y_{ec}, z_{ec}) of the center 46 of the main surface and its normal vector (x_{nc}, y_{nc}, z_{nc}), which are calculated based on all the light-emitting diodes 44a disposed on the main surface at the operation S310, by using at least one filter (e.g., Kalman filter, or extended Kalman filter).

If the number n of the light-emitting diode 44a disposed on the main surface at the operation S200 is 1, the controller 20 may proceed to the operation S310 to calculate the center location of the light-emitting diode 44a and its normal vector as the location (x_{ec}, y_{ec}, z_{ec}) of the final center 46 of the main surface and its final normal vector (x_{nc}, y_{nc}, z_{nc}). The controller 20 may then proceed to operation S160.

Referring back to FIG. 4, at the operation S160, the controller 20 may calculate the posture (x_{mc}, y_{mc}, z_{mc}) of the object 40 and the location (x_{ec}, y_{ec}, z_{ec}) of the center 48 of the object 40 by using the location (x_{ec}, y_{ec}, z_{ec}) of the final center 46 of the main surface, the final normal vector (x_{nc}, y_{nc}, z_{nc}), and the specifications of the object 40 (e.g., the width, the height, and the dimensions between the center of the main surface and the center of the object 40). The description omits a detailed description of the example algorithm because this example algorithm for calculating the posture (x_{mc}, y_{mc}, z_{mc}) of the object 40 and the location (x_{ec}, y_{ec}, z_{ec}) of the center 48 of the object 40 by using the location (x_{ec}, y_{ec}, z_{ec}) of the final center 46 of the main surface, the final normal vector (x_{nc}, y_{nc}, z_{nc}), and the specifications of the object 40 is well known to those skilled in the art.

The controller 20 may then control the posture or the movement of the robot 30 based on the posture (x_{mc}, y_{mc}, z_{mc}) of the object 40 and the location (x_{ec}, y_{ec}, z_{ec}) of the center 48 of the object 40 at operation S170. In one example, the controller 20 may control the driver 32 of the robot 30 to follow the location (x_{ec}, y_{ec}, z_{ec}) of the center 48 of the object 40. In another example, the controller 20 may couple the robot 30 to the object 40 by controlling the posture and the movement of the robot 30 based on the posture (x_{mc}, y_{mc}, z_{mc}) of the object 40 and the location (x_{ec}, y_{ec}, z_{ec}) of the center 48 of the object 40.

Although example embodiments of the present disclosure have been described hereinabove, scopes of the present disclosure are not necessarily limited thereto, and equivalent modifications easily modified by those skilled in the art to which the present disclosure pertains are intended to fall within the scopes and spirit of the present disclosure.

What is claimed is:

1. A method for estimating an object location and an object posture of an object, wherein the object includes marked surfaces, each of the marked surfaces includes at least one mark disposed to be adjacent a given vertex of at least one vertex of a corresponding surface of the marked surfaces, wherein the at least one mark indicates the corresponding surface, and wherein the object includes a first width and a first height between the at least one mark and a first center of the corresponding surface, and wherein a second width, a second height, and a depth between the first center of the corresponding surface and a second center of the object are pre-stored as specifications of the object, the method comprising:
capturing, by a camera mounted on a robot, an image of the object;
recognizing, by a controller, the at least one mark from the image of the object;
determining, by the controller, a main surface among the marked surfaces by using the recognizing of the at least one mark;
determining, by the controller, a mark location of the at least one mark disposed on the main surface;
calculating, by the controller, a final center location and a final normal vector of the main surface by using the determining of the mark location of the at least one mark and the specifications of the object; and
calculating, by the controller, the object location and the object posture of the object by using the final center location and the final normal vector of the main surface and the specifications of the object.

2. The method of claim 1, wherein the at least one mark is a light-emitting diode device that emits light of a given color set based on a given surface of the marked surfaces on which the at least one mark is disposed.

3. The method of claim 2, wherein the image of the object that is captured by the camera includes any one of or any combination of color information on the given color emitted by the light-emitting diode device in the image, pixel information on pixel data of the light-emitting diode device in the image, and transformation information on a transformation relationship between the pixel data and three-dimensional (3D) data of the light-emitting diode device, wherein the 3D data includes depth data.

4. The method of claim 3, wherein the recognizing of the at least one mark from the image of the object comprises detecting at least the given color of light emitted by the light-emitting diode device and the pixel data of the given vertex for a bounding box corresponding to the light-emitting diode device.

5. The method of claim 4, wherein the determining of the main surface comprises determining, as the main surface, a given surface among the marked surfaces on which a largest number of vertices are disposed among all detected vertices.

6. The method of claim 4, wherein the determining of the mark location of the at least one mark disposed on the main surface comprises:
generating 3D vertex data of the given vertex of the bounding box corresponding to the light-emitting diode device disposed on the main surface;
calculating at least two-dimensional (2D) i-th data of an i-th center and an i-th normal vector of an i-th light-emitting diode based on the 3D vertex data of the given vertex of the bounding box corresponding to the i-th light-emitting diode and an i-th size of the bounding box;
determining whether the i-th light-emitting diode is disposed on a left or a right in a width direction by moving the i-th light-emitting diode to the left or the right in the width direction; and
determining whether the i-th light-emitting diode is disposed above or below in a height direction by determining whether an i-th height of the i-th center of the i-th light-emitting diode based on whether the camera is above or below an object height of an object center of the object.

7. The method of claim 6, wherein the determining whether the i-th light-emitting diode is disposed on the left or the right in the width direction by moving the i-th light-emitting diode to the left or the right in the width direction comprises:
calculating a first difference between the i-th normal vector before a movement and the i-th normal vector after the movement by moving the i-th light-emitting diode to the left or the right by a predetermined distance in the width direction;
determining that the i-th light-emitting diode is disposed in a first movement direction if the first difference between the i-th normal vector before the movement and the i-th normal vector after the movement is greater than a predetermined value; and
determining that the i-th light-emitting diode is disposed in a second movement direction opposite to the first movement direction if the first difference between the i-th normal vector before the movement and the i-th normal vector after the movement is the predetermined value or less.

8. The method of claim 6, wherein the calculating of the final center location and the final normal vector of the main surface comprises:
calculating an i-th marker center location and an i-th marker normal vector for each of a first set of main-surface light-emitting diodes disposed on the main surface based on the i-th marker center location for each of the first set of main-surface light-emitting diodes and the specifications of the object; and
calculating the final center location and the final normal vector of the main surface based on and by using the calculated i-th marker center location and the i-th marker normal vector for each of the first set of main-surface light-emitting diodes on the main surface.

9. The method of claim 8, wherein the calculating of the final center location and the final normal vector of the main surface based on and by using the calculated i-th marker center location and the i-th marker normal vector for each of the first set of main-surface light-emitting diodes on the main surface comprises filtering the calculated i-th marker center location and the i-th marker normal vector for all of the first set of main-surface light-emitting diodes on the main surface.

10. The method of claim 1, further comprising controlling, by the controller, the robot based on the object location and the object posture of the object.

11. A system for estimating an object location and an object posture of an object, wherein the object includes marked surfaces, each of the marked surfaces includes at least one mark disposed to be adjacent a given vertex of at least one vertex of a corresponding surface of the marked surfaces, wherein the at least one mark indicates the corresponding surface, and wherein the object includes a first width and a first height between the at least one mark and a first center of the corresponding surface, and wherein a second width, a second height, and a depth between the first center of the corresponding surface and a second center of the object are pre-stored as specifications of the object, the system comprising:
a robot including a driver configured to generate a driving force for the robot and configured to follow or engage with the object;
a camera mounted on the robot and configured to capture an image of the object within a field of view; and
a controller connected to the camera, wherein the controller is configured to receive the image of the object from the camera, wherein the controller is configured to control the robot, and wherein the controller comprises at least one processor and a storage medium storing computer-readable instructions that, when executed by the at least one processor, enable the at least one processor to:
recognize the at least one mark from the image of the object,
determine a main surface among the marked surfaces by using the recognized at least one mark,
determine a mark location of the at least one mark disposed on the main surface,
calculate a final center location and a final normal vector of the main surface by using the determined mark location of the at least one mark and the specifications of the object, and
calculate the object location and the object posture of the object by using the final center location and the final normal vector of the main surface and the specifications of the object.

12. The system of claim 11, wherein the at least one mark is a light-emitting diode device that emits light of a given color set based on a given surface of the marked surfaces on which the at least one mark is disposed.

13. The system of claim 12, wherein the image of the object that is captured by the camera includes any one of or any combination of color information on the given color emitted by the light-emitting diode device in the image, pixel information on pixel data of the light-emitting diode device in the image, and transformation information on a transformation relationship between the pixel data and three-dimensional (3D) data of the light-emitting diode device, wherein the 3D data includes depth data.

14. The system of claim 13, wherein, when recognizing the at least one mark from the image of the object, the instructions further enable the at least one processor to detect at least the given color of light emitted by the light-emitting diode device and the pixel data of the given vertex of for a bounding box corresponding to the light-emitting diode device.

15. The system of claim 14, wherein, when determining the main surface, the instructions further enable the at least one processor to determine, as the main surface, a given surface among the marked surfaces on which a largest number of vertices are disposed among all detected vertices.

16. The system of claim 14, wherein, when determining the mark location of the at least one mark disposed on the main surface, the instructions further enable the at least one processor to:
generate 3D vertex data of the given vertex of the bounding box corresponding to the light-emitting diode device disposed on the main surface;
calculate at least two-dimensional (2D) i-th data of an i-th center and an i-th normal vector of an i-th light-emitting diode based on the 3D vertex data of the given vertex of the bounding box corresponding to the i-th light-emitting diode and an i-th size of the bounding box;
determine whether the i-th light-emitting diode is disposed on a left or a right in a width direction by moving the i-th light-emitting diode to the left or the right in the width direction; and
determine whether the i-th light-emitting diode is disposed above or below in a height direction by determining whether an i-th height of the i-th center of the i-th light-emitting diode based on whether the camera is above or below an object height of an object center of the object.

17. The system of claim 16, wherein, when determining whether the i-th light-emitting diode is disposed on the left or the right in the width direction, the instructions further enable the at least one processor to:
calculate a first difference between the i-th normal vector before a movement and the i-th normal vector after the movement by moving the i-th light-emitting diode to the left or the right by a predetermined distance in the width direction;
determine that the i-th light-emitting diode is disposed in a first movement direction if the first difference between the i-th normal vector before the movement and the i-th normal vector after the movement is greater than a predetermined value; and
determine that the i-th light-emitting diode is disposed in a second movement direction opposite to the first movement direction if the first difference between the i-th normal vector before the movement and the i-th normal vector after the movement is the predetermined value or less.

18. The system of claim 16, wherein, when calculating the final center location and the final normal vector of the main surface, the instructions further enable the at least one processor to:
calculate an i-th marker center location and an i-th marker normal vector for each of a first set of main-surface light-emitting diodes disposed on the main surface based on the i-th marker center location for each of the first set of main-surface light-emitting diodes and the specifications of the object; and
calculate the final center location and the final normal vector of the main surface based on and by using the calculated i-th marker center location and the i-th marker normal vector for each of the first set of main-surface light-emitting diodes on the main surface.

19. The system of claim 18, wherein, when calculating the final center location and the final normal vector of the main surface based on and by using the calculated i-th marker center location and the i-th marker normal vector for each of the first set of main-surface light-emitting diodes on, the instructions further enable the at least one processor to filter the calculated i-th marker center location and the i-th marker normal vector for all of the first set of main-surface light-emitting diodes on the main surface.

20. The system of claim 11, wherein the controller is further configured to control the robot based on the object location and the object posture of the object.
